(19) United States
(12) Patent Application Publication
(10) Pub. No.: US 2025/0368045 A1
(43) Pub. Date: Dec. 4, 2025

(54) DRIVING ASSISTANCE APPARATUS AND DRIVING ASSISTANCE METHOD

(71) Applicants: TOYOTA JIDOSHA KABUSHIKI KAISHA, Toyota-shi Aichi-ken (JP); DENSO CORPORATION, Kariya-shi Aichi (JP)

(72) Inventors: Masahiro HIRAKO, Katsushika-ku Tokyo (JP); Arata TAKADA, Toyota-shi Aichi (JP); Yudai SADAKUNI, Koto-ku Tokyo (JP)

(73) Assignees: TOYOTA JIDOSHA KABUSHIKI KAISHA, Toyota-shi Aichi-ken (JP); DENSO CORPORATION, Kariya-shi Aichi (JP)

(21) Appl. No.: 19/213,249

(22) Filed: May 20, 2025

(30) Foreign Application Priority Data
May 28, 2024 (JP) 2024-086201

(51) Int. Cl. B60K 35/81; G07C 5/08

(52) U.S. Cl. CPC B60K 35/81; G07C 5/08; B60K 2360/119

(57) ABSTRACT

A driving assistance apparatus includes a driving assistance unit, a first storage unit, a second storage unit, and a display control unit. When a target of the driving assistance is detected around the vehicle, the driving assistance unit executes driving assistance for the vehicle. The first storage unit stores a content of the driving assistance. The second storage unit stores an image captured by a camera of the vehicle. The display control unit displays, on a display of the vehicle, the content of the driving assistance and the image captured at a position where the driving assistance was executed. The display control unit performs highlight display control to highlight a target of the driving assistance in the image captured by the camera.

### CROSS-REFERENCE TO RELATED APPLICATIONS

This application is based upon and claims the benefit of priority from Japanese Patent Application No. 2024-086201, filed on May 28, 2024, the entire contents of which are incorporated herein by reference.

### TECHNICAL FIELD

The present disclosure relates to a driving assistance apparatus and a driving assistance method.

### BACKGROUND

In the related art, Japanese Unexamined Patent Application Publication No. 2020-52801 is known as a technical document relating to a driving assistance apparatus. Japanese Unexamined Patent Application Publication No. 2020-52801 describes a technique that contributes to improving driving skills by reproducing bird's-eye view video information.

### SUMMARY

In the technique described above, there may be cases where driving assistance is executed while a vehicle is traveling or stopped. In such cases, further improvement is demanded in users' understanding of the content of the driving assistance.

An object of the present disclosure is, therefore, to provide a driving assistance apparatus and a driving assistance method capable of improving a user's understanding of the content of the driving assistance executed for the vehicle.

A driving assistance apparatus according to the present disclosure includes a driving assistance unit configured to execute driving assistance for the vehicle when a target of the driving assistance is detected around the vehicle. The driving assistance apparatus includes a first storage unit configured to store the content of the driving assistance; a second storage unit configured to store an image captured by a camera of the vehicle and a display control unit configured to display the content of the driving assistance and the image captured at a position where the driving assistance was executed on a display of the vehicle. The display control unit is configured to perform highlight display control to highlight the target of the driving assistance in the image.

According to this driving assistance apparatus, the content of the driving assistance is displayed on the display along with the image captured by the camera. Consequently, the user may review the surroundings of the vehicle at the time when the driving assistance was executed while also grasping the content of the driving assistance. Moreover, because the target of the driving assistance is highlighted in the image, the user can more easily understand the content of the driving assistance. Therefore, the driving assistance apparatus enables an improved understanding, by the user, of the content of the driving assistance executed for the vehicle.

The driving assistance apparatus may further include a notification control unit configured to perform a notification for recording an operation history of the driving assistance after execution of the driving assistance. Through this, the user can be prompted to check the recorded operation history of the driving assistance.

The display control unit may be configured to, as the notification for recording the operation history of the driving assistance, display on a map on the display an icon corresponding to the driving assistance at a position corresponding to a position where the driving assistance was executed. In this way, the user can grasp the content of the driving assistance in accordance with the position at which the driving assistance was executed.

The display control unit may be configured to display, as the notification for recording the operation history of the driving assistance, a list in chronological order of the driving assistance executed on the display. In this way, the user can grasp the content of the driving assistance in the chronological order in which it was executed.

Another aspect of the present disclosure is a driving assistance method performed by a computer. The method includes a first storage step of storing the content of driving assistance executed for a vehicle and a second storage step of storing an image captured by a camera of the vehicle. The method includes a display step of displaying the content of the driving assistance and the image captured at a position where the driving assistance was executed on a display of the vehicle. In the display step, highlight display is performed to highlight a target of the driving assistance in the image.

In this driving assistance method, the computer displays the content of the driving assistance along with the image captured by the camera. Consequently, the user may review the surroundings of the vehicle at the time when the driving assistance was executed while also grasping the content of the driving assistance. Moreover, because the target of the driving assistance is highlighted in the image, the user can more easily understand the content of the driving assistance. Therefore, this driving assistance method enables an improved understanding, by the user, of the content of the driving assistance executed for the vehicle.

According to the present disclosure, it becomes possible to provide a driving assistance apparatus and a driving assistance method capable of improving a user's understanding of the content of driving assistance executed for the vehicle.

### BRIEF DESCRIPTION OF THE DRAWINGS

FIG. 1 is a block diagram of a driving assistance apparatus according to one embodiment.

FIG. 2 is a diagram illustrating an example of a notification for recording an operation history of the driving assistance.

FIG. 3 is a diagram illustrating an example of a display screen of the display in which icons are shown according to the content of the driving assistance.

FIG. 4 is a diagram illustrating an example of the display screen of the display when an icon is selected.

FIG. 5 is a diagram illustrating an example of an image at the time of execution of the driving assistance.

FIG. 6 is a diagram illustrating an example of the image in which highlight display control is performed.

FIG. 7 is a flowchart illustrating image storage processing of an ECU shown in FIG. 1.

FIG. 8 is a flowchart illustrating image display processing of the ECU shown in FIG. 1.

### DETAILED DESCRIPTION

Hereinafter, an embodiment of the present disclosure will be described with reference to the accompanying drawings.

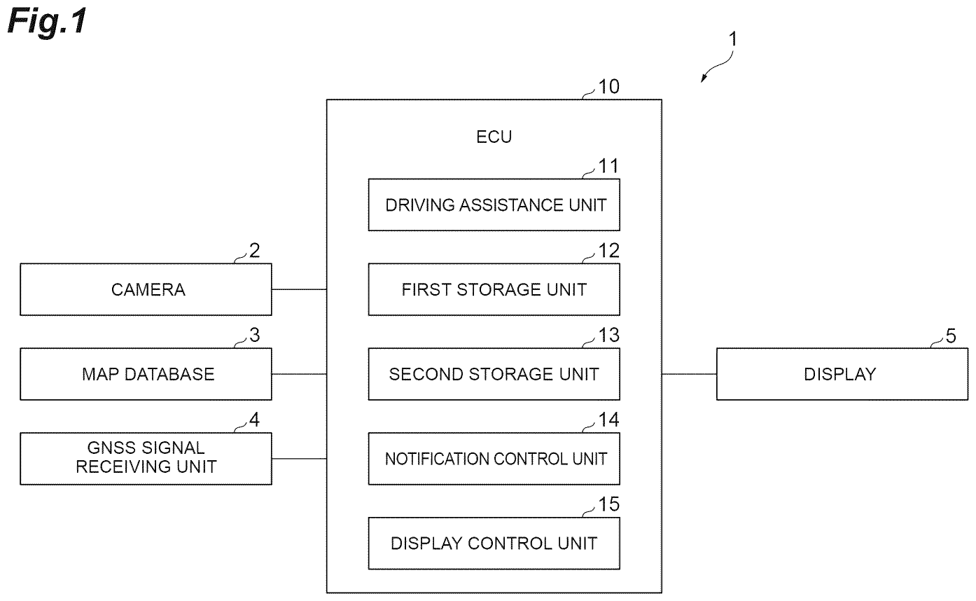

FIG. 1 is a block diagram of a driving assistance apparatus according to the present embodiment. The driving assistance apparatus 1 shown in FIG. 1 is, for example, mounted in a passenger car, a truck, or the like to execute various types of driving assistance. In the present embodiment, the vehicle on which the driving assistance apparatus 1 is mounted is referred to as “the vehicle.”

As shown in FIG. 1, the driving assistance apparatus 1 includes a camera 2, a map database 3, a Global Navigation Satellite System (GNSS) signal receiving unit 4, a display 5, and an Electronic Control Unit (ECU) 10.

The camera 2 is an imaging device that captures a frontal view of the vehicle. The camera 2, for example, is provided on an interior side of the windshield of the vehicle so as to capture an area ahead of the vehicle through the windshield. The camera 2 may be a monocular camera or a stereo camera. In the present embodiment, the camera 2 functions as the camera of a drive recorder for the vehicle. The camera 2 transmits captured images to the ECU 10.

The map database 3 is a database that stores map information. The map database 3 may be formed on a server that can communicate with the vehicle. The map information may include, for example, information relating to roads and intersections. Alternatively, the map database 3 may be formed in a storage device, such as a Hard Disk Drive (HDD), mounted in the vehicle.

The GNSS signal receiving unit 4 receives signals from positioning satellites to measure the position of the vehicle (for example, the latitude and longitude of the vehicle). The GNSS signal receiving unit 4 transmits position information of the vehicle to the ECU 10.

The display 5 is mounted in the cabin of the vehicle. The display 5 may be, for example, a center display provided on the dashboard of the vehicle. The display 5 may be a display of a tablet-type computer that can be installed in the vehicle, or may be a Head Up Display (HUD). The display 5 may be a touch panel display that can be operated by touch. The display 5 displays predetermined information based on control signals transmitted from the ECU 10.

The ECU 10 is a computer (an electronic control unit) having a Central Processing Unit (CPU) and a storage device such as a Read Only Memory (ROM) or a Random Access Memory (RAM). In the ECU 10, for example, various functions are realized by executing a program stored in the storage device using the CPU. The ECU 10 is provided, for example, in the vehicle.

From a functional standpoint, the ECU 10 includes a driving assistance unit 11, a first storage unit 12, a second storage unit 13, a notification control unit 14, and a display control unit 15.

The driving assistance unit 11 is configured to execute driving assistance for the vehicle when a target of the driving assistance is detected around the vehicle. The driving assistance may include, for example, vehicle speed control such as inter-vehicle distance control and steering control such as lane departure prevention control. The driving assistance may also include vehicle support by a so-called advanced safety system. The target of the driving assistance is an object necessary for execution of the driving assistance, such as a preceding vehicle or lane demarcation line. For instance, in inter-vehicle distance control, the target is a preceding vehicle traveling ahead of the vehicle. In lane departure prevention control, the target is a lane demarcation line on the road. The target of the driving assistance also covers targets set in well-known driving assistance.

For example, if the distance between the vehicle and the preceding vehicle becomes equal to or less than a predetermined threshold value, the driving assistance unit 11 transmits a control signal to a brake actuator of the vehicle to execute deceleration control (vehicle speed control) of the vehicle. Also, if the lateral distance between the vehicle and a lane demarcation line becomes equal to or less than a predetermined threshold value (indicating that the vehicle could possibly depart its lane), the driving assistance unit 11 transmits a control signal to a steering actuator of the vehicle to execute steering control for lane departure prevention.

The first storage unit 12 stores the content of the driving assistance executed by the driving assistance unit 11. The first storage unit 12 stores the content of the driving assistance for each position at which the driving assistance was executed. Specifically, when the driving assistance is executed, the first storage unit 12 stores, in association with each other, the content of the driving assistance and the position on the map at which the driving assistance was executed. The first storage unit 12 also stores the content of the driving assistance for each timing at which the driving assistance was executed, associating the content of the driving assistance with the timing at which it was executed. The first storage unit 12 stores the content of that driving assistance in association with the corresponding timing when driving assistance is executed at a predetermined timing.

The second storage unit 13 stores an image captured by the camera 2 of the vehicle. This image is a so-called drive recorder image. The second storage unit 13 stores images captured by the camera 2 for each position at which the driving assistance is executed. Specifically, when the driving assistance is executed at a certain position, the second storage unit 13 stores, in association with each other, the content of the driving assistance and the image captured at that position. The second storage unit 13 also stores images captured by the camera 2 for each timing at which the driving assistance is executed, associating the content of the driving assistance with the image captured at that timing. The second storage unit 13 stores at least the images captured during the period in which the driving assistance is executed. Note that the first storage unit 12 and the second storage unit 13 may be implemented as a single, integrated storage entity. The first storage unit 12 and the second storage unit 13 may, for example, perform storage processing in an in-vehicle database, or may store data on a server outside the vehicle.

The notification control unit 14 is configured to perform a notification for recording an operation history of the driving assistance. For example, the notification control unit 14 performs the notification of the operation history recording after execution of the driving assistance. For instance, after the driving assistance is executed, if the vehicle's ignition changes from the OFF state to the ON state or from the ON state to the OFF state, the notification control unit 14 may perform the notification for recording the operation history of the driving assistance. Alternatively, the notification control unit 14 may perform this notification when the vehicle remains stopped for a certain time after the driving assistance is executed. The notification control unit 14 may perform the notification for recording the operation history of the driving assistance immediately after execution of the driving assistance if the vehicle speed is less than a predetermined threshold value.

A notification for recording the operation history of the driving assistance is a notification to inform the user that the operation history of the driving assistance has been recorded. By receiving this notification, the user becomes aware that the operation history of the driving assistance is available for checking. For example, the notification control unit 14 may display an image on the display 5 to perform the notification for recording the operation history of the driving assistance. The notification control unit 14 may also output a voice simultaneously with displaying the image.

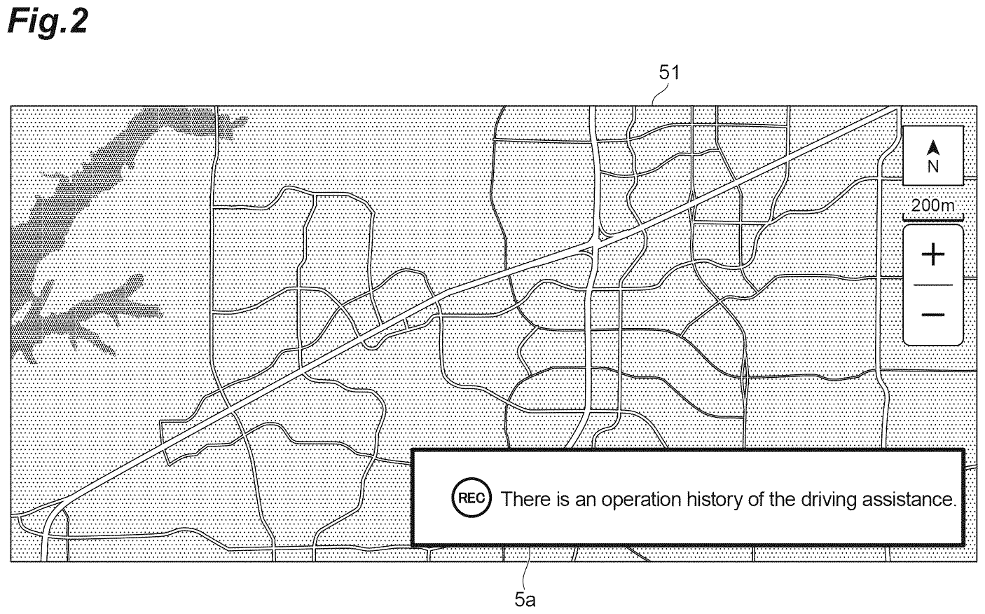

FIG. 2 is a diagram illustrating an example of the notification for recording the operation history of the driving assistance. As shown in FIG. 2, the notification control unit 14 may display a first image 5a on the display screen 51 of the display 5 to notify the user that the operation history of the previously executed driving assistance has been recorded. The first image 5a may be, for example, a text display indicating the existence of the operation history of the driving assistance. The first image 5a may include an icon to indicate the operation history of the driving assistance, or it may consist solely of the icon. When a user (for example, the driver) sees the first image 5a, the user recognizes that the operation history of the driving assistance has been recorded and becomes able to check it.

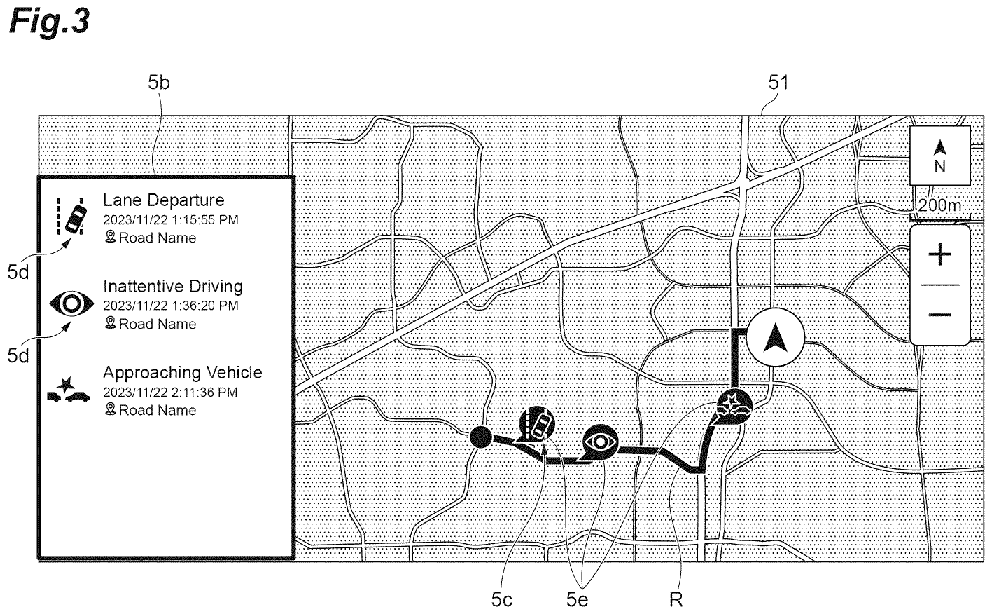

The display control unit 15 is configured to display the content of the driving assistance and the image captured at the position where the driving assistance was executed on the display screen 51 of the display 5. Specifically, when the user selects (for example, taps with a finger) the first image 5a displayed on the display screen 51, the display control unit 15 displays a second image 5b and a third image 5c on the display screen 51, as exemplified in FIG. 3. FIG. 3 is a diagram illustrating an example of a display screen of the display in which icons are shown according to the content of the driving assistance. Each of the second image 5b and the third image 5c shown in FIG. 3 includes icons indicating the operation history of the driving assistance.

The second image 5b is an image listing the operation history of the driving assistance in chronological order. The second image 5b includes multiple icons 5d corresponding to multiple instances of the operation history. Each icon 5d corresponds to one instance of the driving assistance content, and an icon of a particular shape is displayed according to the content of the driving assistance. In FIG. 3, from top to bottom, icons 5d are shown for “lane departure,” “inattentive driving,” and “approaching vehicle,” in that chronological order.

Each icon 5d may include text that indicates the content of the driving assistance. The text of each icon 5d may include a title of the driving assistance content, the time at which the driving assistance was executed, the road name on which the driving assistance was executed, etc. It is also acceptable to indicate only the title of the driving assistance content or the time at which the driving assistance was executed. Note that displaying text is not mandatory. Alternatively, in the second image 5b, the display control unit 15 may list text items in chronological order, rather than icons 5d, to indicate the content of the driving assistance. In this manner, the display control unit 15 displays, as a notification for recording the operation history of the driving assistance, the chronological list of times at which the driving assistance was executed on the display screen 51 of the display 5. By viewing the second image 5b, the user can grasp the operation history of the driving assistance in chronological order. Note that the icon shapes of the icons 5d may all be identical.

The third image 5c is an image displaying the positions on a map at which the driving assistance was executed. In the third image 5c, the operation history of multiple instances of driving assistance executed along a route R traveled by the vehicle is shown. The third image 5c includes multiple icons 5e corresponding to the multiple instances of the operation history of the driving assistance. Each icon 5e corresponds to the content of one instance of driving assistance executed at one position on the route R. Each icon 5e is displayed as a different icon shape according to the content of the driving assistance. In this manner, the display control unit 15 displays the operation history of the driving assistance for each position at which the driving assistance was executed on the display screen 51 of the display 5. That is, as the notification for recording the operation history of the driving assistance, the display control unit 15 displays on the map on the display 5 an icon corresponding to the driving assistance at a position corresponding to the position where the driving assistance was executed. By viewing the third image 5c, the user can grasp the operation history of the driving assistance in terms of location. Note that the icon shapes of the icons 5e may all be identical.

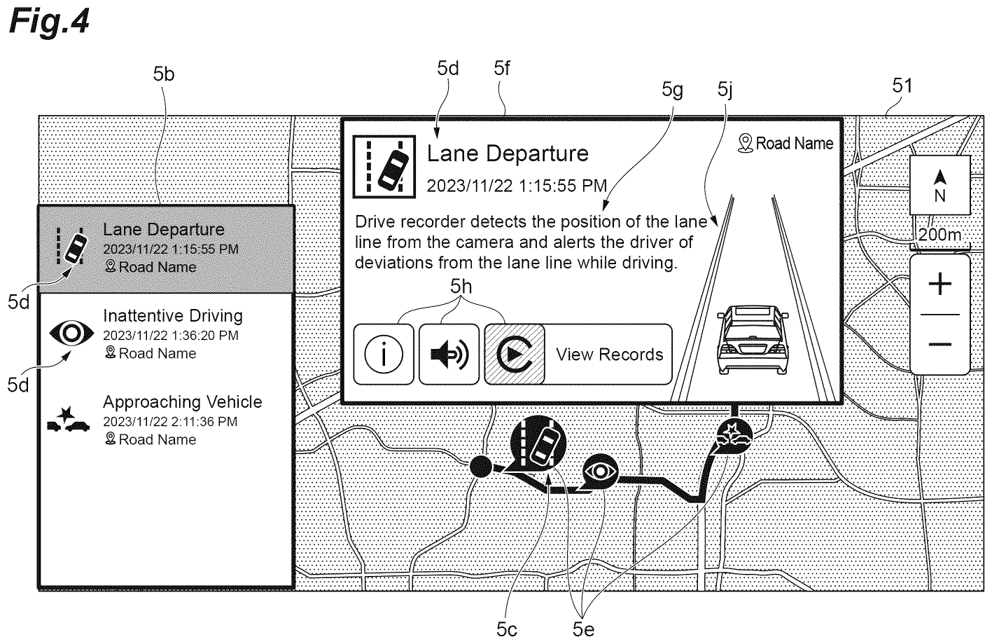

When any icon 5d in the second image 5b or any icon 5e in the third image 5c shown in FIG. 3 is selected (for example, tapped by a finger), the display control unit 15 displays a fourth image 5f on the display screen 51, as illustrated in FIG. 4. FIG. 4 is a diagram illustrating an example of the display screen 51 of the display 5 when the icon 5d or 5e is selected. The fourth image 5f is an image showing detailed information about the operation history of the driving assistance.

The fourth image 5f may include, for example, the icon 5d, text 5g, button icons 5h, and explanatory image 5j. The icon 5d in the fourth image 5f can be identical to the icon 5d in the second image 5b. The text 5g may be text providing a detailed explanation of the content of the driving assistance by the driving assistance unit 11. The button icons 5h may indicate, for example, functions such as settings, voice output, and video playback. By selecting (e.g., tapping) the button icon for the video playback function among the button icons 5h, the user can view the images captured by the camera 2 at the time of execution of the driving assistance. The explanatory image 5j may be a simple illustration explaining the content of the driving assistance executed by the driving assistance unit 11 in detail. By viewing the fourth image 5f, the user can grasp, for example, the position where the driving assistance was executed, the time at which the driving assistance was executed, and the specific content (including reasons) of the driving assistance. Note that the display control unit 15 does not necessarily have to display the first image 5a shown in FIG. 2; it may display at least one of the second image 5b or the third image 5c shown in FIG. 3 from the start as a notification for recording the operation history of the driving assistance.

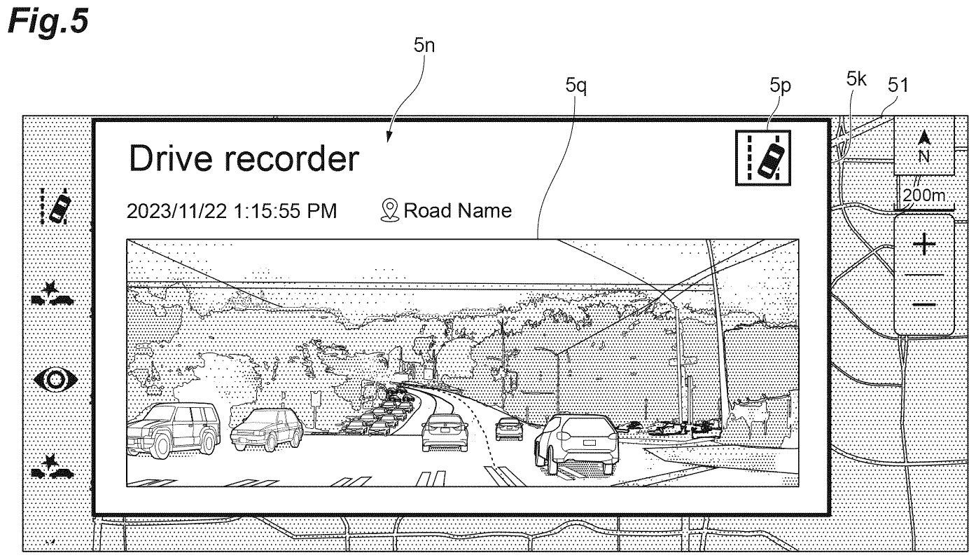

When the button icon 5h (the button icon for the video playback function) in the fourth image 5f shown in FIG. 4 is selected, the display control unit 15 displays a fifth image 5k on the display screen 51, as illustrated in FIG. 5. FIG. 5 is a diagram illustrating an example of an image displayed at the time when the driving assistance was executed. The fifth image 5k is an image that includes the image captured by the camera 2. The fifth image 5k includes text 5n, an icon 5p, and an image 5q. The text 5n shows items such as the title of the image 5q, the timing at which the image 5q was captured, and the position at which it was captured. The icon 5p indicates the content of the driving assistance corresponding to the image 5q. The image 5q is an image captured by the camera 2. When the user selects (e.g., taps) the image 5q shown in FIG. 5, the image captured at the position where the driving assistance was executed is then played back.

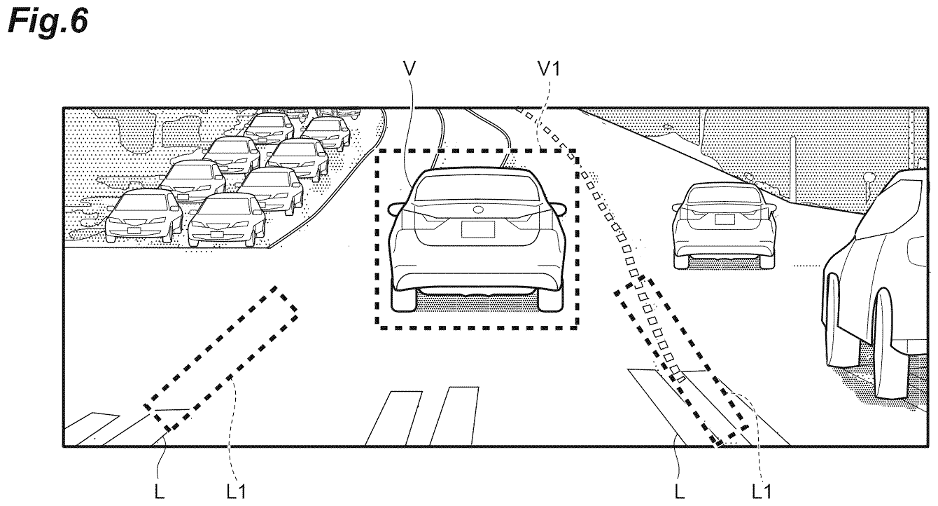

FIG. 6 is a diagram illustrating an example of an image in which highlight display control is performed. As shown in FIG. 6, the display control unit 15 performs highlight display control to highlight the target of the driving assistance in the image being played. Specifically, for example, if the driving assistance unit 11 executes deceleration support for a preceding vehicle V as the target of the driving assistance, the display control unit 15 highlights the preceding vehicle V, which is the target of the driving assistance. The display control unit 15 may, for instance, display an image V1 (a highlighting frame) around the preceding vehicle V in that image, thereby highlighting the preceding vehicle V. If the driving assistance unit 11 executes steering support for a demarcation line L as the target of the driving assistance, the display control unit 15 highlights the demarcation line L in a similar manner. More specifically, in the above-mentioned image, the display control unit 15 may display an image L1 (a highlighting frame) overlaying the demarcation line L, thereby highlighting the demarcation line L. By seeing the image V1 or L1, the user can grasp the content of the driving assistance more specifically and intuitively.

As the highlight display control, the display control unit 15 may display on the screen of the preceding vehicle V a highlighting image in the form of rods, wedges, arrows, or the like. The display control unit 15 may also display text or icons indicating that the preceding vehicle V is the target of the driving assistance, or may change the color of the preceding vehicle V. The same approach may be taken if the target of the driving assistance is a demarcation line.

The display control unit 15 may display, on the display 5, an image for evaluating the appropriateness of the driving assistance. By selecting this image (e.g., tapping), the user can evaluate the appropriateness of the driving assistance. Alternatively, the user may evaluate the appropriateness of the driving assistance by voice input or the like. In such a case, the user may freely comment on the executed driving assistance. The images displayed by the display control unit 15 or the user's evaluation (including voice) may be stored, for example, in a server or elsewhere. In such a case, the display control unit 15 may display on the display 5 an image for obtaining the user's consent.

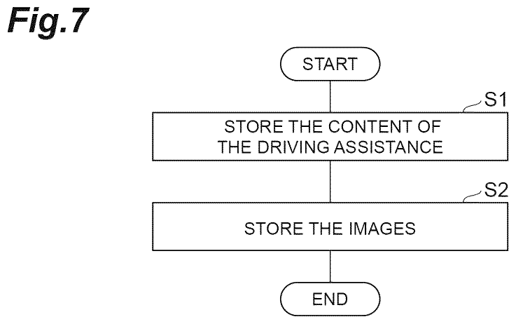

Next, an example of a driving assistance method executed by the ECU 10 (computer) of the driving assistance apparatus 1 will be described with reference to the drawings. FIG. 7 is a flowchart illustrating image storage processing by the ECU 10. As shown in FIG. 7, in step S1 (the first storage step), the ECU 10 stores the content of the driving assistance executed for the vehicle. In step S2 (the second storage step), the ECU 10 stores images captured by the camera 2 of the vehicle. The step S2 is executed simultaneously with step S1, or it may be executed before or after step S1.

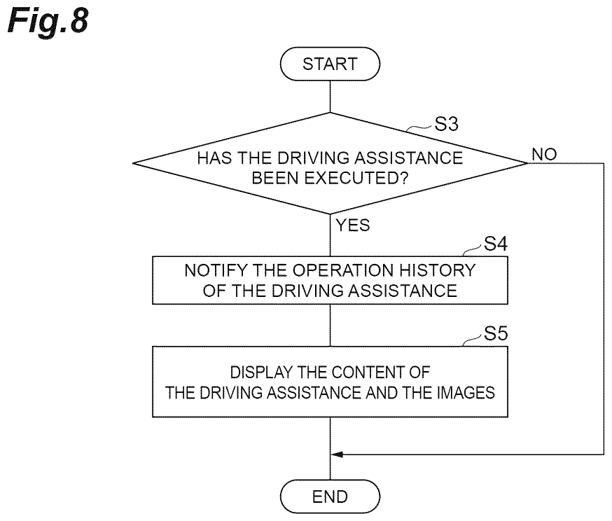

FIG. 8 is a flowchart illustrating image display processing by the ECU 10. As shown in FIG. 8, in step S3 the ECU 10 determines whether the driving assistance has been executed for the vehicle. If the driving assistance has been executed for the vehicle (step S3: YES), the ECU 10 performs a notification for recording the operation history of the driving assistance (step S4). If the driving assistance has not been executed (step S3: NO), the ECU 10 ends the current processing.

In step S5 (the display step), the ECU 10 displays on the display 5 of the vehicle the content of the driving assistance and the image captured at the position where the driving assistance was executed. In step S5, the ECU 10 performs highlight display to highlight the target of the driving assistance in the image.

As described above, in the driving assistance apparatus 1, the content of the driving assistance is displayed on the display 5 along with the image captured by the camera 2. Consequently, the user can review the surroundings of the vehicle at the time when the driving assistance was executed while also grasping the content of the driving assistance. Moreover, because the target of the driving assistance is highlighted in the image, the user can more easily understand the content of the driving assistance. Therefore, according to the driving assistance apparatus 1, it is possible to improve the understanding, by the user, of the content of the driving assistance executed for the vehicle. In addition, easy access can be made to the images captured during execution of the driving assistance, thereby providing a further improvement in the user's understanding of the driving assistance.

The driving assistance apparatus 1 includes the notification control unit 14, which performs the notification for recording the operation history of the driving assistance. Hence, the user can be prompted to confirm the recorded operation history of the driving assistance.

The display control unit 15 displays, as the notification for recording the operation history of the driving assistance, an icon corresponding to the driving assistance on the map of the display 5, at the position corresponding to the position where the driving assistance was executed. Therefore, the user can grasp the content of the driving assistance in accordance with the position at which the driving assistance was executed.

The display control unit 15 may also display, as the notification for recording the operation history of the driving assistance, a list on the display 5 in chronological order of the driving assistance executed. Consequently, the user can grasp the content of the driving assistance in the chronological order of its execution.

According to the driving assistance method of the present embodiment, similarly to the driving assistance apparatus 1, it is possible to improve a user's understanding of the content of the driving assistance executed for the vehicle.

Although one embodiment of the present disclosure has been described above, the present disclosure is not limited to the above embodiment. The driving assistance that the driving assistance apparatus 1 can execute is not limited to one that necessarily requires a target outside the vehicle.

For example, the driving assistance apparatus 1 need not include the notification control unit 14 at all. The driving assistance apparatus 1 may be configured simply to perform highlight display control to highlight the target of the driving assistance, in cases where the user's operation or the like causes the image captured by the camera 2 at the position where the driving assistance was executed to be displayed. Likewise, in the driving assistance method, step S4 need not be executed.

The display control unit 15 may display either of the second image 5b or the third image 5c shown in FIG. 3, rather than both.

The camera 2 need not be the camera for the vehicle's drive recorder. The camera 2 may be, for example, a front camera of the vehicle that records images independently of the drive recorder.

For instance, if the driving assistance unit 11 executes sign recognition assistance with a sign or a traffic light as the target of the driving assistance, the display control unit 15 may highlight that sign or traffic light. If the driving assistance unit 11 executes rear vehicle proximity warning assistance with a rear vehicle as the target of the driving assistance, the display control unit 15 may highlight the rear vehicle. If the driving assistance unit 11 executes avoidance assistance for a parked vehicle on a shoulder of the road as the target of the driving assistance, the display control unit 15 may highlight that parked vehicle. If the driving assistance unit 11 executes notification of delayed start assistance with a traffic light as the target of the driving assistance, the display control unit 15 may highlight that traffic light.

What is claimed is:

1. A driving assistance apparatus comprising:
a driving assistance unit configured to execute driving assistance for a vehicle when a target of the driving assistance is detected around the vehicle;
a first storage unit configured to store a content of the driving assistance;
a second storage unit configured to store an image captured by a camera of the vehicle; and
a display control unit configured to display the content of the driving assistance and the image captured at a position where the driving assistance was executed on a display of the vehicle,
wherein the display control unit is configured to perform highlight display control to highlight the target of the driving assistance in the image.

2. The driving assistance apparatus according to claim 1, further comprising a notification control unit configured to perform a notification for recording an operation history of the driving assistance after execution of the driving assistance.

3. The driving assistance apparatus according to claim 2, wherein the display control unit is configured to, as the notification for recording the operation history of the driving assistance, display on a map on the display an icon corresponding to the driving assistance at a position corresponding to a position where the driving assistance is executed.

4. The driving assistance apparatus according to claim 2, wherein the display control unit is configured to display, as the notification for recording the operation history of the driving assistance, a list in chronological order of the driving assistance executed on the display.

5. A driving assistance method performed by a computer, the method comprising:
a first storage step of storing a content of driving assistance executed for a vehicle;
a second storage step of storing an image captured by a camera of the vehicle; and
a display step of displaying the content of the driving assistance and the image captured at a position where the driving assistance was executed on a display of the vehicle,
wherein, in the display step, highlight display control is performed to highlight a target of the driving assistance in the image.
